(19) United States
(12) Patent Application Publication
(10) Pub. No.: US 2026/0277431 A1
(43) Pub. Date: Sep. 17, 2026

(54) METHOD AND APPARATUS FOR ADJUSTING VIRTUAL KEYS, ELECTRONIC DEVICE, AND STORAGE MEDIUM

(71) Applicant: NETEASE (HANGZHOU) NETWORK CO., LTD., Hangzhou, Zhejiang (CN)

(72) Inventors: Haiyan LIU, Hangzhou, Zhejiang (CN); Jiali LI, Hangzhou, Zhejiang (CN)

(73) Assignee: NETEASE (HANGZHOU) NETWORK CO., LTD., Hangzhou, Zhejiang (CN)

(21) Appl. No.: 19/162,450

(22) PCT Filed: Oct. 23, 2023
(86) PCT No.: PCT/CN2023/125994

§ 371 Date: Sep. 5, 2025

(30) Foreign Application Priority Data
Mar. 6, 2023 (CN) 202310228162.X

(51) Int. Cl. G06F 3/04886; A63F 13/22; A63F 13/355; G06F 3/04847

(52) U.S. Cl. CPC G06F 3/04886; A63F 13/22; G06F 3/04847; A63F 13/355; G06F 2203/04803

(57) ABSTRACT

Provided are a method and apparatus for adjusting virtual keys, an electronic device, and a storage medium. The method includes determining, according to historical operation information of a user, an operation center for each virtual key in a plurality of virtual keys displayed on a terminal device; and adjusting the corresponding virtual key according to the operation center, so as to reduce the distance between a key center of the virtual key and the corresponding operation center.

### CROSS-REFERENCE TO RELATED APPLICATIONS

This application is a U.S. National Stage of International Application No. PCT/CN2023/125994, filed on Oct. 23, 2023, which claims the benefit of priority to Chinese patent application No. 202310228162.X filed on Mar. 6, 2023, both of which are incorporated herein by reference in their entireties for all purposes.

### TECHNICAL FIELD

The present disclosure relates to the field of computer technology, and in particular to methods and devices for adjusting virtual keys, an electronic device, and a storage medium.

### BACKGROUND

In the related art, game applications often have a default button layout. Some game applications allow users to adjust the button positions in the settings. However, since these adjustments in settings often cannot simulate actual combat scenarios, the set button positions still cannot be adapted to the user's actual combat needs, leading to operational errors in combat. This results in users having to repeatedly adjust the settings, affecting the gaming experience.

### SUMMARY

The present disclosure provides a virtual key adjustment method, a virtual key adjustment device, an electronic device, and a computer-readable storage medium.

According to a first aspect of the present disclosure, there is provided a method for adjusting virtual keys, where multiple virtual keys are displayed on a display screen of a terminal device, and the method includes determining an operation center for each virtual key based on historical operation information of a user; and shortening a distance between a key center of the virtual key and corresponding operation center by adjusting corresponding virtual key based on the operation center.

According to a second aspect of the present disclosure, there is provided a device for adjusting virtual keys, where multiple virtual keys are displayed on a display screen of a terminal device, and the device includes an operation center determination module for determining an operation center of each virtual key based on historical operation information of a user; and a virtual key adjustment module for shortening a distance between a key center of the virtual key and corresponding operation center by adjusting corresponding virtual key according to the operation center.

According to a third aspect of the present disclosure, there is provided an electronic device including a processor, a memory, and a computer program stored in the memory and executable on the processor, where the computer program, when executed by the processor, implements the method for adjusting virtual keys according to the first aspect.

According to a fourth aspect of the present disclosure, there is provided a non-transitory computer-readable storage medium storing a computer program, where the computer program, when executed by the processor, implements the method for adjusting virtual keys according to the first aspect.

### BRIEF DESCRIPTION OF THE DRAWINGS

FIG. 1 is a schematic diagram of a virtual key adjustment process in the related art;

FIG. 2 is a flowchart of steps of a virtual key adjustment method according to an embodiment of the present disclosure;

FIG. 3 is a partial schematic diagram of a settings page according to an embodiment of the present disclosure;

FIG. 4 is a schematic diagram of a virtual key adjustment process according to an embodiment of the present disclosure;

FIG. 5 is a schematic diagram of a virtual key adjustment process according to an embodiment of the present disclosure;

FIG. 6 is a schematic diagram of a virtual key adjustment process according to an embodiment of the present disclosure;

FIG. 7 is a schematic diagram of a pop-up dialog box according to an embodiment of the present disclosure;

FIG. 8 is a block diagram of a virtual key adjustment device according to an embodiment of the present disclosure.

### DETAILED DESCRIPTION

To make the above-mentioned objectives, features, and advantages of the present disclosure more readily apparent, the present disclosure is further described in detail below with reference to the accompanying drawings and specific embodiments. It should be noted that the described embodiments are only some, and not all, of the embodiments of the present disclosure. All other embodiments derived by persons of ordinary skill in the art based on the embodiments of the present disclosure without inventive effort are within the scope of protection of the present disclosure.

Related mobile games often have a default layout for the main buttons. However, due to individual differences in hand shape, finger length, and usage habits, the default layout cannot meet individual needs.

Some game applications allow users to adjust button positions in settings. However, these settings often fail to simulate combat scenarios, resulting in the set button positions still not being compatible with the user's actual combat needs. This can lead to in-game combat errors, forcing users to repeatedly adjust their settings, impacting the gaming experience.

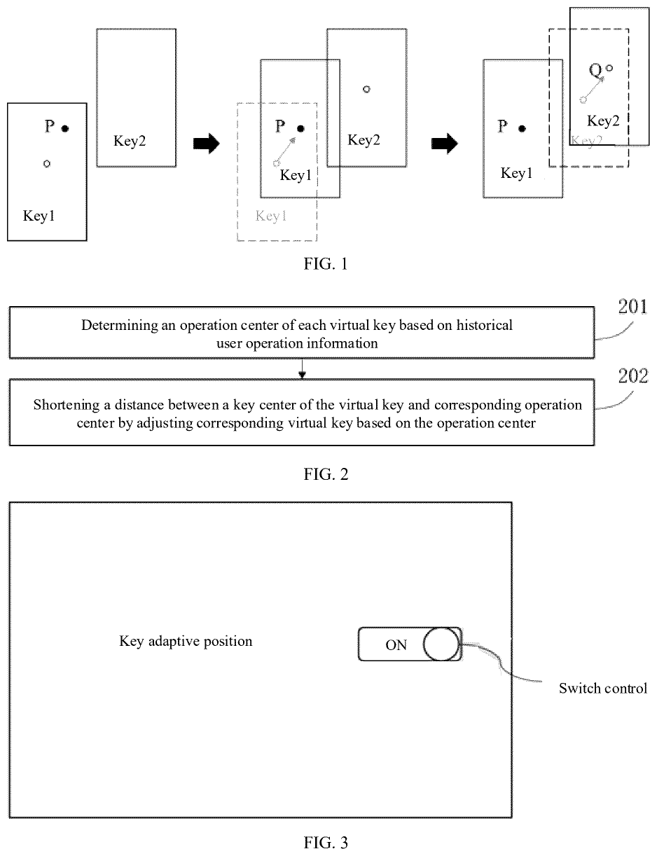

To address the shortcomings of the related art, the inventors have devised a method for monitoring user target operation information on a target key to determine the optimal position for the target key in actual usage scenarios and then moving the center of the target key to that optimal position. However, after the target key's center moves to the optimal position, it may overlap with other keys. To ensure the target key's optimal position, the other keys that overlap with it need to be moved. As shown in FIG. 1, when there are keys 1 and 2 in the interface, key 1 is the target key, and the optimal position for key 1 is P (indicated by a solid circle in the figure). When the key center of key 1 (indicated by a hollow circle in the figure, where the hollow circle with solid outline represents the current key center and the hollow circle with dashed outline represents the original key center) is moved to position P, keys 1 and 2 overlap. At this point, the key center of key 2 is moved to position Q, so that keys 1 and 2 do not overlap. This approach may cause to widen the gap between the adjusted other keys and the user's needs for those other keys.

In view of this, the embodiments of the present disclosure provide a method for adjusting virtual keys that adaptively adjusts each virtual key based on the historical operation information of the user to shorten the distance between the key center of each virtual key and the corresponding operation center, so that the adjusted overall virtual key better meets the user's personalized needs in actual usage scenarios.

A virtual key adjustment method provided in the embodiments of the present disclosure can be executed on a local terminal device or a server. When the virtual key adjustment method is executed on a server, it can be implemented and executed based on a cloud interaction system, where the cloud interaction system includes a server and a client device.

In an embodiment, the cloud interaction system can run various cloud applications, such as cloud gaming. For example, the cloud gaming refers to a gaming mode based on cloud computing. In the cloud gaming, the execution entity of the game program and the presenting entity of the game screen are separated. The virtual key adjustment method is stored and executed on the cloud gaming server, while the client device receives and sends data and presents the game screen. For example, the client device can be a display device with data transmission capabilities located near the user, such as a first terminal device, a television, a computer, or a PDA. However, the virtual key adjustment method is performed on the cloud gaming server in the cloud. When playing a game, the player operates his/her client device to send operational instructions to the cloud gaming server. The cloud gaming server runs the game according to the operational instructions, encodes and compresses data including the game screen, virtual keys, etc., and returns the data to the client device via the network. Finally, the client device decodes and outputs the game screen.

In an embodiment, taking a game as an example, a local terminal device stores the game program and is configured to present the game screen. The local terminal device is configured to interact with the player through a graphical user interface (GUI), i.e., conventionally downloading, installing, and running the game program on an electronic device. The local terminal device can provide the GUI to the player in various ways, such as rendering it on the terminal's display or providing it through holographic projection. For example, the local terminal device may include a display and a processor. The display is configured to display the GUI, which includes the game screen, and the processor is configured to run the game, generate the GUI, and control the display of the GUI on the display.

FIG. 2 illustrates a method for adjusting virtual keys according to an embodiment of the present disclosure. By running an application, multiple virtual keys can be displayed on the terminal device's display. The terminal device can be an electronic device such as a smartphone, tablet, game console, e-book reader, multimedia player, wearable device, etc. The application can be executed on the terminal device. For example, a game program is executed on the processor of the terminal device and the game screen and virtual keys for controlling the game are displayed on the display of the terminal device. The application can also be executed on another terminal device connected to the terminal device by wire or wireless connection. For example, a game program is executed on the processor of another terminal device connected to the terminal device, the game screen is displayed on the display of another terminal device and meanwhile the virtual keys for controlling the game are displayed on the display of the terminal device. The application can also be executed on a server connected to the terminal device. For example, a game program is executed on the server and the game screen and virtual keys for controlling the game are displayed on the display of the terminal device. For another example, a game program is executed on the server, the game screen is displayed on the display of another terminal device and the virtual keys for controlling the game are displayed on the display of the terminal device.

The method may include the following steps 201 and 202:
Step 201: determining an operation center of each virtual key based on historical operation information of a user.

For example, after a game starts, a user can trigger a virtual key to play the game. Therefore, trigger position information when the user triggers a virtual key during the game can be obtained. This trigger position information is the historical operation information.

The historical operation information includes historical single-key operation information for each virtual key. Based on the historical single-key operation information corresponding to each virtual key, the operation center of each virtual key can be obtained.

Step 202: shortening a distance between a key center of the virtual key and corresponding operation center by adjusting corresponding virtual key based on the operation center.

After obtaining the operation center of each virtual key, the corresponding virtual key can be adjusted based on the position of the operation center, including adjusting the position of the virtual key and/or adjusting the shape of the virtual key. This shortens the distance between the key center of the virtual key and the corresponding operation center, i.e., the distance between the new key center of each adjusted virtual key and the corresponding operation center is less than the distance between the original key center of the virtual key and the operation center.

The embodiment of the present disclosure determines the operation center of each virtual key based on the historical operation information of the user and adjusts the corresponding virtual key based on the operation center to shorten the distance between the key center of the virtual key and the corresponding operation center. This allows for adaptive adjustment of the virtual key based on the historical operation information of the user, making the adjusted virtual key more suitable for the user's usage habit in the actual usage scenario. This avoids repeated adjustment of the virtual key by the user, simplifies the user's virtual key adjustment process, improves the efficiency of virtual key adjustment, and enhances the user experience.

The following further describes the virtual key adjustment method in this example embodiment.

In some embodiments of the present disclosure, while an application is running, the user can adjust the position and/or shape of the virtual key corresponding to the application to display multiple virtual keys on the terminal device's display screen. It is understood that the multiple virtual keys displayed on the terminal device's display screen may be virtual keys that have been adjusted by the user.

In step 201, determining the operation center of each virtual key based on the historical operation information of the user.

Each virtual key has a corresponding function and triggering method. The triggering method may include a touch operation involving contact with the virtual key, such as single-clicking, sliding, double-clicking, and long-pressing, etc. acting on the virtual key. The triggering method may also include a non-contact operation with the virtual key, such as an operation of placing the projection of an operating medium on the virtual key. The historical operation information refers to user-performed operations that trigger virtual keys. This historical operation information of user can be obtained by monitoring the triggering position of the operating medium on the display screen when the function of the virtual key is triggered. The operating medium may be a finger, a stylus, or the like.

Historical operation information includes historical single-key operation information for each virtual key. Based on the historical single-key operation information corresponding to each virtual key, the operation center of each virtual key can be obtained. It is understood that for each virtual key, its historical single-key operation information includes at least one trigger position information associated with the virtual key. For example, for a virtual key triggered by sliding, the trigger position information may include click position information derived from the quantified sliding trajectory of the sliding operation, or the start and end position information of the sliding operation. For a virtual key triggered by long pressing, the trigger position information may include the contact point position information of the long press operation. By analyzing all the trigger position information in the historical single-key operation information, the center point among all the trigger position information can be obtained. This center point is the operation center of the virtual key. In other words, the operation center of a virtual key represents the user's usage habits when triggering the virtual key in actual usage scenarios. It can more accurately reflect a position of the virtual key actually needed to be set, facilitating subsequent adaptive adjustment of the virtual key based on the operation center of the virtual key, resulting in a virtual key that better meets the user's personalized needs.

In some embodiments of the present disclosure, a switch control for controlling the adjustment function of the virtual key can be added to the application's settings page. As shown in FIG. 3, a switch control for key adaptive position can be set on the application's settings page. This switch control for key adaptive position is a switch control for controlling the adjustment function of the virtual keys. When the switch control for key adaptive position is turned on, the above-mentioned step of determining the operation center of each virtual key based on the historical operation information of the user is performed. When the switch control for key adaptive position is turned off, the above-mentioned step of determining the operation center of each virtual key based on the historical operation information of the user is not performed. It is understood that in some embodiments of the present disclosure, the above-mentioned step 201 may include:

in response to activation of the key adjustment control, determining the operation center of each virtual key based on the historical operation information of the user.

In this embodiment, upon detecting a user's activation of a switch control for key adaptive position, the historical operation information of the user is obtained and, based on this information, the operation center of each virtual key is determined. The user can then independently determine whether to allow adaptive key position adjustment, thereby meeting the needs of different users in different scenarios. For example, when a user (device owner) temporarily lends his/her terminal device to another person, since the current user (other person) using the terminal device is not the owner, adaptive key position adjustment is generally not desired. Therefore, the function of adaptive key position adjustment can be disabled by turning off the switch control for key adaptive position.

Furthermore, in some embodiments of the present disclosure, in addition to adding a switch control for controlling the adjustment function of the virtual keys to the application's setting page, a period setting input box for indicating the virtual key adaptive adjustment period, or multiple different adjustment period options for indicating the virtual key adaptive adjustment period, can be added to allow the user to independently determine the virtual key adaptive adjustment period. It will be understood that in some embodiments of the present disclosure, determining the operation center of each virtual key based on the historical operation information of the user in response to the activation of the key adjustment control may include:

determining a target adjustment period in response to the activation of the key adjustment control, and when the target adjustment period expires, determining the operation center of each virtual key based on the historical operation information of the user during the adjustment period.

In this embodiment, the user can set or select an adjustment period before enabling the switch control for key adaptive position. After the user enables the switch control for key adaptive position, the adjustment period set or selected by the user is obtained, i.e., the target adjustment period is determined, and user operation information is collected during the target adjustment period. When the target adjustment period expires, the key center of each virtual key is determined based on the historical operation information of the user collected during the target adjustment period. If the user does not set or select an adjustment period, the historical operation information of the user is collected according to a default adjustment period.

Taking gaming as an example, if the determined target adjustment period is 10 games, after the switch control for key adaptive position is enabled, user operation information during the subsequent 10 games is obtained. After the 10th game ends, the operation center of each virtual key is determined based on the currently obtained historical operation information.

In step 202, the distance between the key center of the virtual key and the corresponding operation center is shortened by adjusting the corresponding virtual key based on the operation center.

Since the operation center more accurately reflects the user's actual needs for virtual keys in actual usage scenarios, after determining the operation center of each virtual key, the position and/or shape of the corresponding virtual key can be adjusted based on the operation center to shorten the distance between the key center of each virtual key and the corresponding operation center, so that all virtual keys better meet the user's personalized needs.

In some embodiments of the present disclosure, shortening the distance between the key center of the virtual key and the corresponding operation center by adjusting the corresponding virtual key based on the operation center may include:

moving the virtual key toward the corresponding operation center so that the key center of the virtual key coincides with the corresponding operation center.

When adjusting virtual keys in this embodiment, each virtual key can be moved sequentially or simultaneously toward the corresponding operation center. Movement stops when the key center of a virtual key coincides with the corresponding operation center, so that the operation center is located at the center of the moved virtual key. If there is no conflict between the moved virtual keys, that is, if there is no overlap between the key areas of the moved virtual keys, the positions of the moved virtual keys at this time are used as the final positions of the virtual keys. If there is conflict between the moved virtual keys, further processing is required for the moved virtual keys. Various processing methods are provided below and are not detailed here.

In some embodiments of the present disclosure, after moving the virtual keys toward the corresponding operation center so that the key centers of the virtual keys coincide with the corresponding operation centers, the method may further include:

if there is conflict between the moved virtual keys, determining an adjustment vector for each conflicting key based on the operation center of each conflicting key and the original key center. The starting point of the adjustment vector is the operation center of the corresponding conflicting key and the end point is the original key center of the corresponding conflicting key;

moving each conflicting key along the direction of the corresponding adjustment vector until the conflict disappears.

After the virtual keys are moved to a position where their key centers coincide with corresponding operation centers, the moved positions of each virtual key are obtained. If there is a conflict between the moved virtual keys, that is, if there is overlap between the key areas of the moved virtual keys, the conflicting virtual keys are identified. For easy identification, the identified virtual keys are marked as conflicting keys. Adjustment vectors for respective conflicting keys are determined based on the operation centers of the conflicting keys and the original key centers. It can be understood that for each conflicting key, an adjustment vector is generated with its operation center as the starting point and the original key center as the end point.

Then, each conflicting key is moved in the direction of the corresponding adjustment vector, and stops moving when the conflict disappears. The conflicting keys can be moved simultaneously or sequentially during the movement. When the conflicting keys are moved simultaneously, the distance moved per unit time for each conflicting key can be equal, or the ratio of the distance moved per unit time for each conflicting key to the corresponding adjustment vector can be equal. When the conflicting keys are moved sequentially, the distance per movement for each conflicting key can be equal, or the ratio of the distance per movement for each conflicting key to the corresponding adjustment vector can be equal.

In some embodiments of the present disclosure, moving each conflicting key along the direction of the corresponding adjustment vector until the conflict disappears includes:

determining a movement speed of each conflicting key;

moving each conflicting key simultaneously along the direction of the corresponding adjustment vector at corresponding movement speed;

when the conflict with the target conflicting key disappears, stopping the movement of the target conflicting key.

The target conflicting key can be any conflicting key. In this embodiment, during the movement of the conflicting keys, the movement speed of each conflicting key can be determined first. The movement speeds of different conflicting keys can vary. For example, the movement speed can be related to the length of the adjustment vector corresponding to the conflicting key, or it can be related to the priority of the conflicting key. For example, a conflicting key with a higher priority has a relatively lower movement speed, so that the conflicting key with a higher priority is closer to the corresponding operation center when the conflict is resolved. Multiple conflicting keys can be moved simultaneously to improve the efficiency of adaptive key adjustment. For each conflicting key, during the movement process, when it no longer conflicts with other virtual keys (other than itself), the movement of the conflicting key can be stopped.

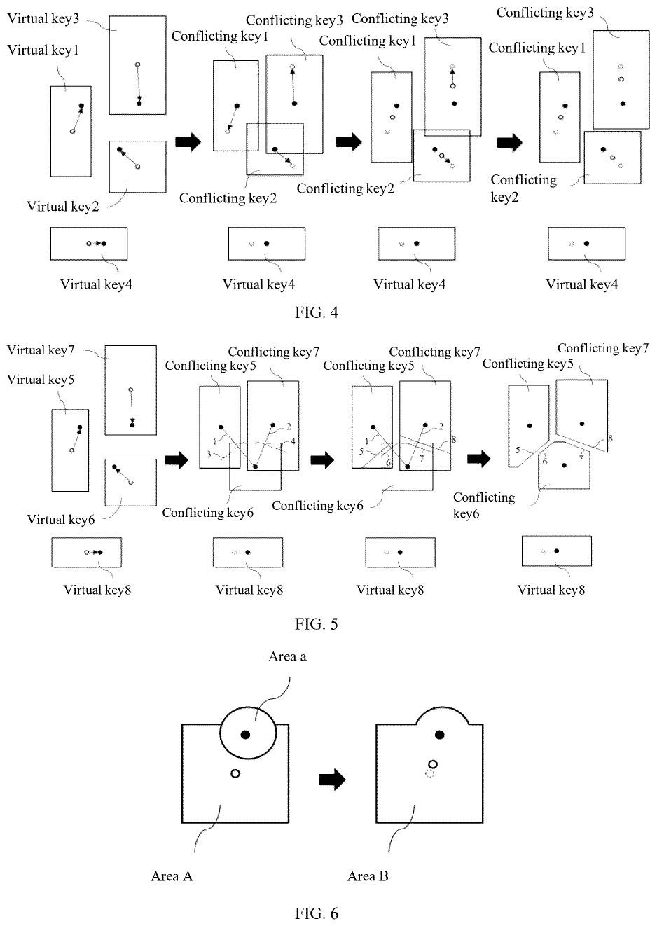

As shown in FIG. 4, after virtual keys 1, 2, 3, and 4 are moved to positions where their key centers (represented by hollow circles in the figure, where the hollow circle with solid outline represents the current key center and the hollow circle with dashed outline represents the original key center) coincide with their corresponding operation centers (represented by solid circles in the figure), conflicts arise between virtual keys 1 and 2, and between virtual key 2 and 3. Therefore, virtual keys 1, 2, and 3 are marked as conflicting keys 1, 2, and 3, respectively. Virtual key 4, which does not conflict, remains unchanged. Conflicting keys 1, 2, and 3 are moved along the corresponding adjustment vectors. The conflict with conflicting key 1 disappears first. When this disappears, movement of conflicting key 1 is stopped. Since the conflict between conflicting keys 2 and 3 still exist when the conflict with conflicting key 1 disappears, movement of conflicting keys 2 and 3 continues. When the conflicts between conflicting keys 2 and 3 disappear, movement of conflicting keys 2 and 3 is stopped, thereby achieving adaptive key adjustment.

Further, in some embodiments of the present disclosure, determining the movement speed of each conflicting key may include:

determining the movement speed corresponding to each conflicting key based on the length of the adjustment vector for each conflicting key; the movement speed is proportional to the length of the corresponding adjustment vector, and the ratio of the movement speeds of different conflicting keys is equal to the ratio of the lengths of the corresponding adjustment vectors.

In this embodiment, the corresponding movement speed can be determined based on the length of the adjustment vector for each conflicting key. It will be understood that, in this embodiment, conflicting keys with different adjustment vector lengths have different corresponding movement speeds. Specifically, the movement speed is proportional to the length of the corresponding adjustment vector, and the ratio of the movement speeds of different conflicting keys is equal to the ratio of the lengths of the corresponding adjustment vectors. That is, the ratio of the movement speed of each conflicting key to the length of the corresponding adjustment vector is the same, which means that each conflicting key moves in proportion to the length of its corresponding adjustment vector.

For example, if the adjustment vector length of conflicting key 1 is a and the adjustment vector length of conflicting key 2 is b, then the movement speed of conflicting key 1 may be a/c, and correspondingly, the movement speed of conflicting key 2 may be b/c.

In some embodiments of the present disclosure, after moving the virtual keys toward the corresponding operation centers so that the key centers of the virtual keys coincide with the corresponding operation centers, the method may further include:

if there is a conflict between the moved virtual keys, cutting respective conflicting key to separate the conflicting keys.

In this embodiment, when there is a conflict between the moved virtual keys, the conflicting virtual keys, i.e., the conflicting keys, may be obtained and separated by cutting to resolve the conflict. Cutting methods may include cutting based on the overlapping area between the conflicting keys or cutting based on the perpendicular bisector of the line connecting the operation centers of the conflicting keys.

In some embodiments of the present disclosure, cutting respective conflicting keys to separate the conflicting keys may include:

determining a line connecting two conflicting keys based on the operation centers of the two conflicting keys;

separating the two conflicting keys by cutting the two conflicting keys based on the perpendicular bisector of the line.

In this embodiment, a line connecting the two conflicting keys is obtained by connecting operation centers of two conflicting keys, i.e., the operation centers of the conflicting keys are connected pairwise. Two conflicting keys connected by a line can be cut along the perpendicular bisector of the line to separate the two conflicting keys and resolve the conflict.

Furthermore, in some embodiments of the present disclosure, cutting the two conflicting keys along the perpendicular bisector of the line to separate the two conflicting keys may include:

translating the perpendicular bisector by a preset distance toward the operation center of the first of the two conflicting keys to obtain a first parallel line;

translating the perpendicular bisector by a preset distance toward the operation center of the second of the two conflicting keys to obtain a second parallel line;

cutting the first conflicting key along the first parallel line, and cutting the second conflicting key along the second parallel line to separate the first and second conflicting keys.

In the embodiment, after the line connecting the two conflicting keys is determined, the perpendicular bisector of the line can be further determined, the perpendicular bisector is translated along the direction of the operation center of one of the conflicting keys by a preset distance to obtain a first parallel line, and the perpendicular bisector is translated along the direction of the operation center of the other conflicting key by the same distance to obtain a second parallel line. For ease of distinction, one of the conflicting keys is referred to as the first conflicting key, and the other conflicting key is referred to as the second conflicting key. The first conflicting key is cut along the first parallel line, retaining the portion where the operation center of the first conflicting key is located, and the second conflicting key is cut along the second parallel line, retaining the portion where the operation center of the second conflicting key is located, thereby separating the first conflicting key and the second conflicting key to resolve the conflict.

As shown in FIG. 5, after virtual keys 5, 6, 7, and 8 move to a position where their key centers (represented by hollow circles in the figure, where the hollow circle with solid outline represents the current key center and the hollow circle with dashed outline represents the original key center) coincide with their corresponding operation centers (represented by solid circles in the figure), conflicts arise between virtual keys 5 and 6, and between virtual key 6 and 7. Therefore, virtual keys 5, 6, and 7 are marked as conflicting keys 5, 6, and 7, respectively.

For conflicting keys 5 and 6, a line 1 connecting the operation centers of conflicting keys 5 and 6 can be obtained. For conflicting keys 6 and 7, a line 2 connecting the operation centers of conflicting keys 6 and 7 can be obtained. Based on lines 1 and 2, the corresponding perpendicular bisector 3 and perpendicular bisector 4 can be determined, respectively. Then the perpendicular bisector 3 is translated by 10 pixels toward conflicting keys 5 and 6, respectively, to obtain a first parallel line 5 and a second parallel line 6. The perpendicular bisector 4 is translated by 10 pixels toward conflicting keys 6 and 7, respectively, to obtain a first parallel line 7 and a second parallel line 8.

Using the first parallel line 5 to cut the conflicting key 5, we split the conflicting key 5 into two parts, retaining the part where the operation center of conflicting key 5 is located and discarding the part that does not contain the operation center. Similarly, using the second parallel line 6 to cut the conflicting key 6, we split the conflicting key 6 into two parts, retaining the part where the operation center of conflicting key 6 is located and discarding the part that does not contain the operation center. The resulting conflicting keys 5 and 6 after cut are separated from each other.

Similarly, using the first parallel line 7 to cut the conflicting key 6, we retain the part where the operation center of the conflicting key 6 is located; and using the second parallel line 8 to cut the conflicting key 7, we retain the part where the operation center of conflicting key 7 is located. The resulting conflicting keys 6 and 7 after cut are separated from each other.

In some embodiments of the present disclosure, shortening the distance between the key center of the virtual key and the corresponding operation center by adjusting the corresponding virtual keys based on the operation center may include:

determining a movement vector for each virtual key based on an original key center and an operation center of each virtual key, where a starting point of the movement vector is the original key center of the corresponding virtual key and an end point is the operation center of the corresponding virtual key;

moving each virtual key in the direction of the corresponding movement vector, ensuring that the adjusted virtual keys do not conflict with each other.

In this embodiment, when the virtual keys are adjusted, each virtual key may be moved sequentially or simultaneously toward the corresponding operation center, and movement may be stopped when nearly conflicts. The resulting adjusted virtual key position may be considered to be the position where the key center is closest to the operation center without changing the original shape of the virtual key.

For example, for each virtual key, a corresponding movement vector may be generated with the original key center of the virtual key as the starting point and the corresponding operation center as the end point. The virtual key is then moved in the direction of the corresponding movement vector while simultaneously detecting the edge positions of each virtual key. When the distance between any two virtual keys equals a preset distance, movement of the two virtual keys is stopped. The preset distance can be set based on actual needs. For example, the preset distance can be 10 pixels or 20 pixels.

During the movement process, the virtual keys can be moved simultaneously or sequentially. When the virtual keys are moved simultaneously, the movement distance of each virtual key per unit time can be equal, or the ratio of the movement distance of each virtual key per unit time to its corresponding movement vector can be equal. When the virtual keys are moved sequentially, the distance per movement of each virtual key can be equal, or the ratio of the distance per movement of each virtual key to its corresponding movement vector can be equal.

In some embodiments of the present disclosure, shortening the distance between the key center of the virtual key and the corresponding operation center by moving each virtual key along the direction of the corresponding movement vector can include:

determining an adjustment speed for each virtual key;

simultaneously moving each virtual key along the direction of the corresponding movement vector at the corresponding adjustment speed, and ensuring that the adjusted virtual keys do not conflict with each other.

During the virtual key adjustment process in this embodiment, the adjustment speed of each virtual key can be determined. The adjustment speed indicates how fast the corresponding virtual key moves along the direction of the motion vector. The adjustment speed can vary for different virtual keys. For example, the adjustment speed can be related to the length of the motion vector corresponding to the virtual key, or it can be related to the priority of the virtual key. For example, virtual keys with higher priorities have correspondingly faster adjustment speeds, so that virtual keys with higher priorities are closer to the corresponding operation center when they stop moving. Multiple virtual keys can also move simultaneously to improve the efficiency of adaptive key adjustment. During the adjustment process, for each virtual key, if the distance between the virtual key and other virtual keys (excluding itself) reaches a preset distance, the virtual key can stop moving, along with other virtual keys with the same distance from it. Alternatively, during the adjustment process, if the distance between the virtual key and other virtual keys is less than or equal to 0, a rollback operation can be performed. Namely, the virtual key and the other virtual keys are moved in the opposite direction until the distance between the virtual key and the other virtual keys is greater than 0, and then stop moving.

Furthermore, in some embodiments of the present disclosure, determining the adjustment speed of each virtual key may include:

determining the adjustment speed corresponding to each virtual key based on the length of the motion vector of each virtual key; the adjustment speed is proportional to the length of the corresponding motion vector, and the ratio of the adjustment speeds of different virtual keys is equal to the ratio of the lengths of the corresponding motion vectors.

In this embodiment, the corresponding adjustment speed may be determined based on the length of the motion vector of each virtual key. Specifically, the adjustment speed is proportional to the length of the corresponding motion vector, and the ratio of the adjustment speeds of different virtual keys is equal to the ratio of the lengths of the corresponding motion vectors. That is, the ratio of the adjustment speed to the length of the corresponding motion vector is the same for each virtual key, meaning that each virtual key moves in equal proportion to the length of its corresponding motion vector.

In some embodiments of the present disclosure, before adjusting the corresponding virtual key based on the operation center to shorten the distance between the key center of the virtual key and the corresponding operation center, whether the distance between the operation center and the original key center of the corresponding virtual key is greater than a preset distance threshold may be determined first. If the distance between the original key center of the virtual key and the corresponding operation center is not greater than the preset distance threshold, it may be determined that the virtual key meets the user's personalized needs and no adjustment may be performed on the virtual key. When the distance between the original key center of the virtual key and the corresponding operation center is greater than a preset distance threshold, the corresponding virtual key is adjusted based on the operation center to shorten the distance between the key center of the virtual key and the corresponding operation center.

In some embodiments of the present disclosure, shortening the distance between the key center of the virtual key and the corresponding operation center by adjusting the corresponding virtual key based on the operation center may include:

when the operation area corresponding to the operation center is not within the corresponding virtual key, merging the virtual key with the operation area to obtain a new virtual key.

In this embodiment, when the virtual keys are adjusted, the operation area corresponding to each operation center is first determined based on each operation center. The operation area can be a circular area with a preset radius and the operation center as the center, or a region with a preset area and the operation center as the center point. A determination is then made as to whether the operation area corresponding to the operation center is within the corresponding virtual key. If so, the virtual key meets the user's usage requirements. If not, the virtual key and the operation area are merged to obtain a new virtual key. That is, the union of the original key area of the virtual key and the corresponding operation area is taken as the new key area of the new virtual key.

As shown in FIG. 6, the operation center of virtual key 9 (represented by a solid circle in the figure) corresponds to the operation area a. The original key area of virtual key 9 is area A. Since part of area a is not within area A, area a and area A are merged to form area B, i.e., area B=area a U area A. This area B is the adjusted new key area of virtual key 9. The new key center of virtual key 9 (represented by a hollow circle in the figure, where the hollow circle with solid outline represents the current key center and the hollow circle with dashed outline represents the original key center) is closer to the operation center than the original key center. That is, the distance between the new key center and the operation center is smaller than the distance between the original key center and the operation center.

In some examples, when there is a conflict between the new virtual keys, i.e., when the new virtual keys overlap, a conflict resolution method can be determined based on the relationship between the conflicting area and the operation areas corresponding to the two conflicting new virtual keys. A new virtual key is a virtual key whose key area includes the corresponding operation area, and a conflicting area is the area where two new virtual keys overlap.

For example, a new virtual key can be divided into an operation area portion and an original area portion, where the original area portion refers to the area of the new key area excluding the operation area. If the conflicting area is where the operation area portion of a new virtual key overlaps with the original area portion of another new virtual key, the original area portion of the other new virtual key can be cut based on the conflicting area, discarding the portion of the other new virtual key located in the conflicting area, thereby separating the two new virtual keys to resolve the conflict. If the conflicting area is the operation area portions of two new virtual keys, the operation area portions of the two new virtual keys can be segmented based on the perpendicular bisector of the line connecting the operation centers of the two new virtual keys, thereby separating the two new virtual keys to resolve the conflict.

Furthermore, referring to FIG. 7, in some embodiments of the present disclosure, after performing the aforementioned adjustment of the corresponding virtual key based on the operation center to shorten the distance between the key center of the virtual key and the corresponding operation center, the method may further include:

displaying a pop-up dialog box on the display screen; the pop-up dialog box includes the relative position of the adjusted virtual key and the display screen, or the positional relationship between the adjusted virtual key and the corresponding original virtual key, and the pop-up dialog box further includes an accept control and a refuse control;

in response to a triggering operation on the accept control, displaying the adjusted virtual key on the display screen;

in response to a triggering operation on the refuse control, displaying the original virtual key on the display screen.

In this embodiment, after the adjustment for each virtual key is completed, a pop-up dialog box may be displayed on the terminal device's display screen. This pop-up dialog box displays the relative position of the adjusted virtual key and the display screen. For example, in FIG. 7, a scaled-down display screen's displayable interface and the adjusted virtual key are displayed on the display screen. Alternatively, the positional relationship between the adjusted virtual key and the corresponding original virtual key may be displayed. For example, the adjusted virtual key may be displayed in a different color than the original virtual key, or an arrow or other indicator may be used between the adjusted virtual key and the corresponding original virtual key. The pop-up dialog box may also display an accept control and a refuse control. The accept control indicates to use the adjusted virtual key as the virtual key for subsequent use, i.e., accepting the current adaptive adjustment result. The refuse control indicates to maintain the original virtual key, i.e., refusing the current adaptive adjustment result. When the user selects the accept control, the adjusted virtual key is displayed on the display screen. When the user selects the refuse control, the original virtual key is displayed on the display screen.

The pop-up dialog box displays information about the adjusted virtual key to the user, allowing the user to choose whether to use the adjusted virtual key as the virtual key for subsequent use based on their personal needs, thereby ensuring that the subsequently displayed virtual keys better meet their needs.

Furthermore, the information of virtual keys obtained through adaptive adjustments of multiple different users can be summarized, and then target information of at least part of the virtual keys can be determined based on the summarized data. The target information may include the shape and/or position information of the virtual keys, and then the target information can be used as default information of the corresponding virtual keys. The default information refers to the shape and/or position information of the virtual keys before the user makes personalized adjustments.

In the embodiments of the present disclosure, the operation center of each virtual key is determined based on the historical operation information of the user; and the corresponding virtual key is adjusted based on the operation center to shorten the distance between the key center of the virtual key and the corresponding operation center. Specifically, adjusting the corresponding virtual key based on the operation center to shorten the distance between the key center of the virtual key and the corresponding operation center may involve moving the key center of the virtual key to coincide with the corresponding operation center. If conflicts exist between the moved virtual keys, each conflicting key is moved along the direction of a corresponding adjustment vector or is cut to resolve the conflict. Alternatively, adjusting the corresponding virtual key based on the operation center to shorten the distance between the key center of the virtual key and the corresponding operation center may involve moving each virtual key along the direction of a corresponding movement vector to ensure that the adjusted virtual keys do not conflict with each other; or merging the key area of the virtual key with the operation area corresponding to the operation center. This allows for adaptive adjustment of the virtual key based on the historical operation information of the user, making the adjusted virtual key more suitable for the user's actual usage habits. This avoids repeated adjustment of the virtual key by the user, simplifies the user's virtual key adjustment process, improves the efficiency of virtual key adjustment, and enhances the user experience.

It should be noted that, for simplicity, the method embodiments are described as a series of actions. However, those skilled in the art should be aware that the embodiments of the present disclosure are not limited by the order of the actions described, as certain steps may be performed in a different order or simultaneously. Furthermore, those skilled in the art should also be aware that the embodiments described in this description are preferred embodiments, and the actions described are not necessarily required for the embodiments of the present disclosure.

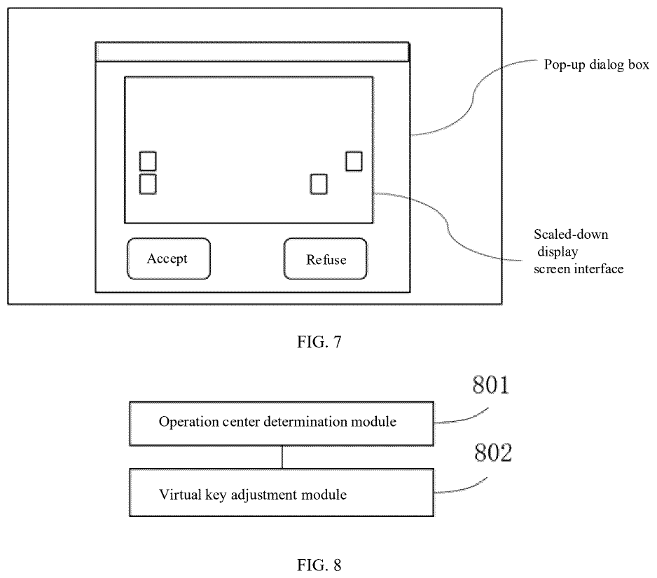

Referring to FIG. 8, a block diagram of an embodiment of a virtual key adjustment device of the present disclosure is shown. Corresponding to the embodiment of the virtual key adjustment method, multiple virtual keys can be displayed on a terminal device's display screen by running an application. The device may include the following modules:

an operation center determination module 801 configured to determine an operation center of each virtual key based on historical operation information of a user;

a virtual key adjustment module 802 configured to shorten a distance between a key center of a virtual key and corresponding operation center by adjusting the corresponding virtual key based on the operation center.

In some embodiments of the present disclosure, the virtual key adjustment module 802 may include:

a first movement module configured to move the virtual key toward the corresponding operation center so that the key center of the virtual key coincides with the corresponding operation center.

In some embodiments of the present disclosure, the virtual key adjustment module 802 may further include:

a first conflict determination module, configured to, if a conflict exists between the moved virtual keys, determine an adjustment vector for each conflicting key based on the operation center and the original key center of each conflicting key, with a starting point of the adjustment vector being the operation center of the corresponding conflicting key and an end point being the original key center of the corresponding conflicting key;

a first conflict handling module, configured to move each conflicting key along the direction of the corresponding adjustment vector until the conflict disappears.

In some embodiments of the present disclosure, the first conflict handling module may include:

a movement speed determination module, configured to determine a movement speed of each conflicting key;

a movement speed-based movement module, configured to simultaneously move each conflicting key at a corresponding movement speed along the direction of the corresponding adjustment vector;

a movement stop module, configured to stop moving a target conflicting key when conflict with the target conflicting key disappears.

In some embodiments of the present disclosure, the movement speed determination module may specifically determine the movement speed of each conflicting key based on the length of its adjustment vector. The movement speed is proportional to the length of the corresponding adjustment vector, and the ratio of the movement speeds of different conflicting keys is equal to the ratio of the lengths of the corresponding adjustment vectors.

In some embodiments of the present disclosure, the virtual key adjustment module 802 may further include:

a second conflict handling module, configured to, if a conflict exists between the moved virtual keys, cut respective conflicting keys to separate the conflicting keys.

In some embodiments of the present disclosure, the second conflict handling module may include:

a connection line determination module, configured to determine a connection line between two conflicting keys based on the operation centers of the two conflicting keys;

a connection line-based cutting module, configured to cut the two conflicting keys based on the perpendicular bisector of the connection line to separate the two conflicting keys. The connection line-based cutting module may include:

a first parallel line determination module, configured to obtain a first parallel line by translating the perpendicular bisector toward the operation center of the first of the two conflicting keys by a preset distance;

a second parallel line determination module, configured to obtain a second parallel line by translating the perpendicular bisector toward the operation center of the second of the two conflicting keys by a preset distance;

a cutting and separation module, configured to cut the first conflicting key based on the first parallel line and cut the second conflicting key based on the second parallel line to separate the first and second conflicting keys.

In some embodiments of the present disclosure, the virtual key adjustment module 802 may include:

a movement vector determination module, configured to determine a movement vector for each virtual key based on the original key center and the operation center of each virtual key, where the starting point of the movement vector is the original key center of the corresponding virtual key and the end point is the operation center of the corresponding virtual key;

a movement vector-based adjustment module, configured to move each virtual key along the direction of the corresponding movement vector and ensure that the adjusted virtual keys do not conflict with each other.

In some embodiments of the present disclosure, the movement vector-based adjustment module may include:

an adjustment speed determination module, configured to determine the adjustment speed of each virtual key;

an adjustment speed-based adjustment module, configured to move each virtual key simultaneously along the direction of the corresponding movement vector at the corresponding adjustment speed and ensure that the adjusted virtual keys do not conflict with each other.

In some embodiments of the present disclosure, the adjustment speed determination module is specifically configured to determine the adjustment speed corresponding to each virtual key based on the length of the movement vector of each virtual key; the adjustment speed is proportional to the length of the corresponding movement vector, and the ratio of the adjustment speeds of different virtual keys is equal to the ratio of the lengths of the corresponding movement vectors.

In some embodiments of the present disclosure, the virtual key adjustment module 802 may specifically adjust the corresponding virtual key based on the operation center when the distance between the original key center of the virtual key and the corresponding operation center is greater than a preset distance threshold, thereby shortening the distance between the key center of the virtual key and the corresponding operation center.

In some embodiments of the present disclosure, the virtual key adjustment module 802 may include:

a merging processing module configured to merge the virtual key with the operation area when the operation area corresponding to the operation center is not within the corresponding virtual key to obtain a new virtual key.

In some embodiments of the present disclosure, the operation center determination module 801 may specifically determine the operation center of each virtual key based on historical operation information of a user in response to an activation operation for the key adjustment control.

In some embodiments of the present disclosure, the operation center determination module 801 may specifically determine a target adjustment period in response to an activation operation for the key adjustment control, and when the target adjustment period expires, determine the operation center of each virtual key based on the historical operation information of the user within the adjustment period.

In some embodiments of the present disclosure, the device may further include:

a dialog box display module configured to display a pop-up dialog box on the display screen; the pop-up dialog box includes the relative position of the adjusted virtual key and the display screen, or the positional relationship between the adjusted virtual key and the corresponding original virtual key, and further includes an accept control and a refuse control;

a first response module configured to display the adjusted virtual key on the display screen in response to a triggering operation on the accept control;

a second response module configured to display the original virtual key on the display screen in response to a triggering operation on the refuse control.

In the embodiments of the present disclosure, the operation center of each virtual key is determined based on the historical operation information of the user; and the corresponding virtual key is adjusted based on the operation center to shorten the distance between the key center of the virtual key and the corresponding operation center. Specifically, adjusting the corresponding virtual key based on the operation center to shorten the distance between the key center of the virtual key and the corresponding operation center may involve moving the key center of the virtual key to coincide with the corresponding operation center. If conflicts exist between the moved virtual keys, each conflicting key is moved along the direction of a corresponding adjustment vector or is cut to resolve the conflict. Alternatively, adjusting the corresponding virtual key based on the operation center to shorten the distance between the key center of the virtual key and the corresponding operation center may involve moving each virtual key along the direction of a corresponding movement vector to ensure that the adjusted virtual keys do not conflict with each other; or merging the key area of the virtual key with the operation area corresponding to the operation center. This allows for adaptive adjustment of the virtual key based on the historical operation information of the user, making the adjusted virtual key more suitable for the user's actual usage habits. This avoids repeated adjustment of the virtual key by the user, simplifies the user's virtual key adjustment method, improves the efficiency of virtual key adjustment, and enhances the user experience.

Since the device embodiment is substantially similar to the method embodiment, its description is relatively brief. For relevant details, please refer to the description of the method embodiment.

The embodiments of the present disclosure also provide an electronic device including a processor, a memory, and a computer program stored on the memory and executable on the processor. When executed by the processor, the computer program implements the steps of the virtual key adjustment method described above.

The embodiments of present disclosure also provide a computer-readable storage medium storing the computer program. When executed by the processor, the computer program implements the steps of the virtual key adjustment method described above.

The various embodiments in this description are described in a progressive manner. Each embodiment focuses on the differences from other embodiments. Reference will be made to the same or similar parts between the various embodiments.

Those skilled in the art will appreciate that the embodiments of the present disclosure can be provided as methods, apparatuses, or computer program products. Therefore, the embodiments of the present disclosure may take the form of entirely hardware embodiments, entirely software embodiments, or embodiments combining software and hardware. Furthermore, the embodiments of the present disclosure may take the form of a computer program product implemented on one or more computer-usable storage media (including but not limited to disk storage, CD-ROMs, optical storage, etc.) containing computer-usable program code.

The embodiments of the present disclosure are described with reference to the flowcharts and/or block diagrams of the methods, terminal devices (systems), and computer program products according to the embodiments of the present disclosure. It should be understood that each process and/or box in the flowchart and/or block diagram, as well as the combination of the processes and/or boxes in the flowchart and/or block diagram, can be implemented by computer program instructions. These computer program instructions can be provided to a processor of a general-purpose computer, a special-purpose computer, an embedded processor, or other programmable data processing terminal device to produce a machine, so that the instructions executed by the processor of the computer or other programmable data processing terminal device generate a device for implementing the functions specified in one or more processes in the flowchart and/or one or more boxes in the block diagram.

These computer program instructions may also be stored in a computer-readable memory that directs a computer or other programmable data processing terminal device to operate in a specific manner, such that the instructions stored in the computer-readable memory produce an article of manufacture including instruction means that implement the functions specified in one or more flowcharts and/or one or more blocks in a block diagram.

These computer program instructions may also be loaded onto a computer or other programmable data processing terminal device, causing the computer or other programmable data processing terminal device to execute a series of operating steps to produce a computer-implemented process, whereby the instructions executed on the computer or other programmable data processing terminal device provide steps for implementing the functions specified in one or more flowcharts and/or one or more blocks in a block diagram.

All information acquisition actions proposed in the embodiments of the present disclosure are performed in compliance with the relevant data protection laws and policies of the country in which they are located and with the authorization granted by the owner of the corresponding device.

Although embodiments of the present disclosure have been described, those skilled in the art may make additional changes and modifications to these embodiments once they understand the basic inventive concept. Therefore, the appended claims are intended to be interpreted as covering the embodiments as well as all changes and modifications that fall within the scope of the embodiments of this disclosure.

Finally, it should be noted that, throughout the description, relational terms such as first and second are used solely to distinguish one entity or operation from another, and do not necessarily require or imply any actual relationship or order between these entities or operations. Furthermore, the terms “comprise”, “include,” or any other variations thereof are intended to encompass non-exclusive inclusion, such that a process, method, article, or terminal device including a list of elements includes not only those elements but also other elements not explicitly listed, or includes elements inherent to such process, method, article, or terminal device. Without further limitation, elements specified by the phrase “including a . . . ” do not preclude the presence of additional identical elements in the process, method, article, or terminal device comprising the recited elements.

The above detailed description of the virtual key adjustment method and apparatus, electronic device, and storage medium provided by the present disclosure. Specific examples are used herein to illustrate the principles and implementations of the present disclosure. The description of the above examples is intended only to facilitate understanding of the method and its core concepts. Furthermore, those skilled in the art will appreciate that variations in the specific implementation and scope of application are possible based on the principles of the present disclosure. In summary, the contents of this description should not be construed as limiting the present disclosure.

1. A method for adjusting virtual keys, wherein multiple virtual keys are displayed on a display screen of a terminal device, and the method comprises:
determining an operation center for each virtual key based on historical operation information of a user; and
shortening a distance between a key center of the virtual key and corresponding operation center by adjusting corresponding virtual key based on the operation center.

2. The method according to claim 1, wherein shortening the distance between the key center of the virtual key and the corresponding operation center by adjusting the corresponding virtual key based on the operation center comprises:
aligning the key center of the virtual key to coincide with the corresponding operation center by moving the virtual key toward the corresponding operation center.

3. The method according to claim 2, further comprising:
in response to a conflict existing between moved virtual keys, determining an adjustment vector for each conflicting key based on the operation center and an original key center of each conflicting key with conflict, wherein a starting point of the adjustment vector is the operation center of corresponding conflicting key and an end point is the original key center of the corresponding conflicting key; and
moving each conflicting key along a direction of corresponding adjustment vector until the conflict disappears.

4. The method according to claim 3, wherein moving each conflicting key along the direction of the corresponding adjustment vector until the conflict disappears comprises:
determining a movement speed of each conflicting key;
moving each conflicting key simultaneously along the direction of the corresponding adjustment vector at corresponding movement speed; and
in response to a conflict with a target conflicting key disappearing, stopping movement of the target conflicting key.

5. The method according to claim 4, wherein determining the movement speed of each conflicting key comprises:
determining corresponding movement speed of each conflicting key based on a length of the adjustment vector of each conflicting key; the movement speed is proportional to the length of corresponding adjustment vector, and a ratio of the movement speeds of different conflicting keys is equal to a ratio of the lengths of the corresponding adjustment vectors.

6. The method according to claim 2, further comprising:
in response to a conflict existing between moved virtual keys, separating conflicting keys with conflict by cutting the conflicting keys.

7. The method according to claim 6, wherein separating the conflicting keys with conflict by cutting the conflicting keys comprises:
determining a line connecting two conflicting keys based on the operation centers of the two conflicting keys; and
separating the two conflicting keys by cutting the two conflicting keys based on a perpendicular bisector of the line.

8. The method according to claim 7, wherein separating the two conflicting keys by cutting the two conflicting keys based on the perpendicular bisector of the line comprises:
obtaining a first parallel line by translating the perpendicular bisector by a preset distance toward the operation center of a first conflicting key of the two conflicting keys;
obtain a second parallel line by translating the perpendicular bisector by a preset distance toward the operation center of a second conflicting key of the two conflicting keys; and
separating the first and second conflicting keys by cutting the first conflicting key based on the first parallel line and cutting the second conflicting key based on the second parallel line.

9. The method according to claim 1, wherein shortening the distance between the key center of the virtual key and the corresponding operation center by adjusting the corresponding virtual key based on the operation center comprises:
determining a movement vector for each virtual key based on an original key center and the operation center of each virtual key, wherein a starting point of the movement vector is the original key center of the corresponding virtual key and an end point is the operation center of the corresponding virtual key; and
moving each virtual key in a direction of corresponding movement vector, and ensuring that adjusted virtual keys do not conflict with each other.

10. The method according to claim 9, wherein moving each virtual key in the direction of the corresponding movement vector comprises:
determining an adjustment speed for each virtual key; and
moving each virtual key simultaneously in the direction of the corresponding movement vector at corresponding adjustment speed, and ensuring that the adjusted virtual keys do not conflict with each other.

11. The method according to claim 10, wherein determining the adjustment speed of each virtual key comprises:
determining the adjustment speed corresponding to each virtual key based on a length of the movement vector of each virtual key; the adjustment speed is proportional to the length of corresponding movement vector, and a ratio of the adjustment speeds of different virtual keys is equal to a ratio of the lengths of the corresponding movement vectors.

12. The method according to claim 1, wherein shortening the distance between the key center of the virtual key and the corresponding operation center by adjusting the corresponding virtual key based on the operation center comprises:
in response to a distance between an original key center of the virtual key and the corresponding operation center being greater than a preset distance threshold, shortening the distance between the key center of the virtual key and the corresponding operation center by adjusting the corresponding virtual key based on the operation center.

13. The method according to claim 1, wherein shortening the distance between the key center of the virtual key and the corresponding operation center by adjusting the corresponding virtual key based on the operation center comprises:
in response to an operation area corresponding to the operation center is not within corresponding virtual key, obtaining a new virtual key by merging the virtual key with the operation area.

14. The method according to claim 1, wherein determining the operation center of each virtual key based on the historical operation information of the user comprises:
determining the operation center of each virtual key based on the historical operation information of the user in response to an activation operation for a key adjustment control.

15. The method according to claim 14, wherein determining the operation center of each virtual key based on the historical operation information of the user in response to the activation operation for the key adjustment control comprises:
determining a target adjustment period in response to the activation operation for the key adjustment control, and in response to the target adjustment period expiring, determining the operation center of each virtual key based on the historical operation information of the user within the adjustment period.

16. The method according to claim 1, further comprising:
displaying a pop-up dialog box on the display screen; the pop-up dialog box comprises a relative position of an adjusted virtual key and the display screen, or a positional relationship between the adjusted virtual key and corresponding original virtual key, and the pop-up dialog box further comprises an accept control and a refuse control;
in response to a triggering operation on the accept control, displaying the adjusted virtual key on the display screen;
in response to a triggering operation on the refuse control, displaying the original virtual key on the display screen.

17. (canceled)

18. An electronic device comprising a processor, a memory, and a computer program stored in the memory and executable on the processor, wherein the computer program, when executed by the processor, implements a method comprising:
displaying multiple virtual keys on a display screen of the electronic device;
determining an operation center for each virtual key based on historical operation information of a user; and
shortening a distance between a key center of the virtual key and corresponding operation center by adjusting corresponding virtual key based on the operation center.

19. A non-transitory computer-readable storage medium storing a computer program, wherein the computer program, when executed by the processor, implements a method comprising:
displaying multiple virtual keys on a display screen of the electronic device;
determining an operation center for each virtual key based on historical operation information of a user; and
shortening a distance between a key center of the virtual key and corresponding operation center by adjusting corresponding virtual key based on the operation center.
